(19) United States
(12) Patent Application Publication
(10) Pub. No.: US 2016/0105645 A1
(43) Pub. Date: Apr. 14, 2016

(54) IDENTIFICATION DEVICE, METHOD, AND COMPUTER PROGRAM PRODUCT

(71) Applicant: Kabushiki Kaisha Toshiba, Tokyo (JP)

(72) Inventors: Masaki YAMAZAKI, Fuchu Tokyo (JP); Satoshi ITO, Kawasaki Kanagawa (JP); Tomoki WATANABE, Inagi Tokyo (JP); Tatsuo KOZAKAYA, Kawasaki Kanagawa (JP); Ryuzo OKADA, Kawasaki Kanagawa (JP)

(21) Appl. No.: 14/966,238

(22) Filed: Dec. 11, 2015

Related U.S. Application Data
(63) Continuation of application No. PCT/JP2014/059055, filed on Mar. 20, 2014.

(30) Foreign Application Priority Data
Jun. 14, 2013 (JP) 2013-126003

(51) Int. Cl. H04N 7/18; H04N 5/225; G06T 7/00; H04N 5/235

(52) U.S. Cl. CPC H04N 7/181; H04N 5/2354; H04N 5/2258; G06T 7/004; G06T 2207/10016

(57) ABSTRACT

According to an embodiment, an identification device includes a light emission controller, an image capturing controller, a detector, a position calculator, and an identification unit. The light emission controller individually controls lighting on/off of light-emitting instruments via a network. The image capturing controller controls capturing devices by using identification information of the image capturing devices, and obtains an image sequence captured by each image capturing device. The detector detects, for each image sequence, one or more regions varying in conjunction with lighting on/off of the light-emitting instruments. The position calculator calculates, for each image sequence, a position of the image capturing device that captures the image sequence by using a position of the light-emitting instrument performing lighting on/off causing each region. The identification unit identifies each image capturing device specified by the calculated position and each image capturing device specified by the identification information.

### CROSS-REFERENCE TO RELATED APPLICATIONS

This application is a continuation of PCT international application Ser. No. PCT/JP2014/059055 filed on Mar. 20, 2014, which designates the United States and which claims the benefit of priority from Japanese Patent Application No. 2013-126003, filed on Jun. 14, 2013; the entire contents of which are incorporated herein by reference.

### FIELD

Embodiments described herein relate generally to an identification device, a method, and a computer program product.

### BACKGROUND

There have been known image capturing devices connectable to a network, such as a surveillance camera installed in a place such as an office. Accordingly, the use of identification information of an image capturing device, such as an internet protocol (IP) address and a media access control (MAC) address, enables control of the image capturing device via a network. In the next-generation building and energy management system (BEMS), technologies to sense presence of a person and control lighting and air-conditioning by using such an image capturing device are expected.

In a stage of works such as wiring of an image capturing device and installation of the image capturing device in a place such as an office, the identification information of the image capturing device is typically not taken into consideration. For this reason, correspondence between a mounting position and the identification information of the image capturing device becomes unclear. In such a situation, it is not possible to perform control of the image capturing device depending on the mounting position, such as identifying the image capturing device to be controlled by the mounting position and controlling the identified image capturing device by using the identification information of the identified image capturing device.

There is a technique of calculating a camera parameter of a camera by using a reference camera having a known camera parameter, such as a position and a posture, and a landmark.

### BRIEF DESCRIPTION OF THE DRAWINGS

FIG. 1 is a diagram illustrating an example of a configuration of an identification device according to a first embodiment;

FIG. 2 is a perspective view illustrating an example of space to which the identification device according to the first embodiment is applied;

FIG. 3 is a diagram illustrating an example of a position of a light-emitting instrument according to the first embodiment;

FIG. 4 is a diagram illustrating an example of a control signal according to the first embodiment;

FIG. 5 is a diagram illustrating another example of the control signal according to the first embodiment;

FIG. 6 is a diagram illustrating an example of a determination technique of a size of an existence possibility area according to the first embodiment;

FIG. 7 is a diagram illustrating an example of the determination technique of the size of the existence possibility area according to the first embodiment;

FIG. 8 is a diagram illustrating an example of the determination technique of the size of the existence possibility area according to the first embodiment;

FIG. 9 is a diagram illustrating an example of the determination technique of the size of the existence possibility area according to the first embodiment;

FIG. 10 is a diagram illustrating an example of the determination technique of the size of the existence possibility area according to the first embodiment;

FIG. 11 is a diagram illustrating an example of the determination technique of the size of the existence possibility area according to the first embodiment;

FIG. 12 is a diagram illustrating an example of a position calculation result of an image capturing device according to the first embodiment;

FIG. 13 is a diagram illustrating an example of a mapping result according to the first embodiment;

FIG. 14 is a flow chart illustrating an example of an identification process performed by the identification device according to the first embodiment;

FIG. 15 is a diagram illustrating an example of a configuration of an identification device according to a second embodiment;

FIG. 16 is a perspective view illustrating an example of space to which the identification device according to the second embodiment is applied;

FIG. 17 is a diagram illustrating an example of a determination technique of a direction of an image capturing device according to the second embodiment;

FIG. 18 is a diagram illustrating an example of the determination technique of the direction of the image capturing device according to the second embodiment;

FIG. 19 is a diagram illustrating an example of the determination technique of the direction of the image capturing device according to the second embodiment;

FIG. 20 is a diagram illustrating an example of the determination technique of the direction of the image capturing device according to the second embodiment;

FIG. 21 is a diagram illustrating an example of the determination technique of the direction of the image capturing device according to the second embodiment;

FIG. 22 is a diagram illustrating an example of a calculation result of the position and the direction of the image capturing device according to the second embodiment.

FIG. 23 is a diagram illustrating an example of a mapping result according to the second embodiment;

FIG. 24 is a flow chart illustrating an example of an identification process performed by the identification device according to the second embodiment; and

FIG. 25 is a diagram illustrating an example of a hardware configuration of the identification device according to each embodiment and each variation.

### DETAILED DESCRIPTION

According to an embodiment, an identification device includes a light emission controller, an image capturing controller, a detector, a position calculator, and an identification unit. The light emission controller is configured to individually control lighting on/off of a plurality of light-emitting instruments via a network. The image capturing controller is configured to control a plurality of image capturing devices by using identification information of each of the plurality of image capturing devices, and obtain an image sequence captured by each of the plurality of image capturing devices. The detector is configured to detect, for each image sequence, one or more regions that vary in conjunction with lighting on/off of the plurality of light-emitting instruments. The position calculator is configured to calculate, for each image sequence, a position of the image capturing device that captures the image sequence by using a position of the light-emitting instrument that performs lighting on/off causing each of the one or more regions. The identification unit is configured to identify each of the plurality of image capturing devices specified by the calculated position and each of the plurality of image capturing devices specified by the identification information.

Embodiments will be described in detail below with reference to the accompanying drawings.

### First Embodiment

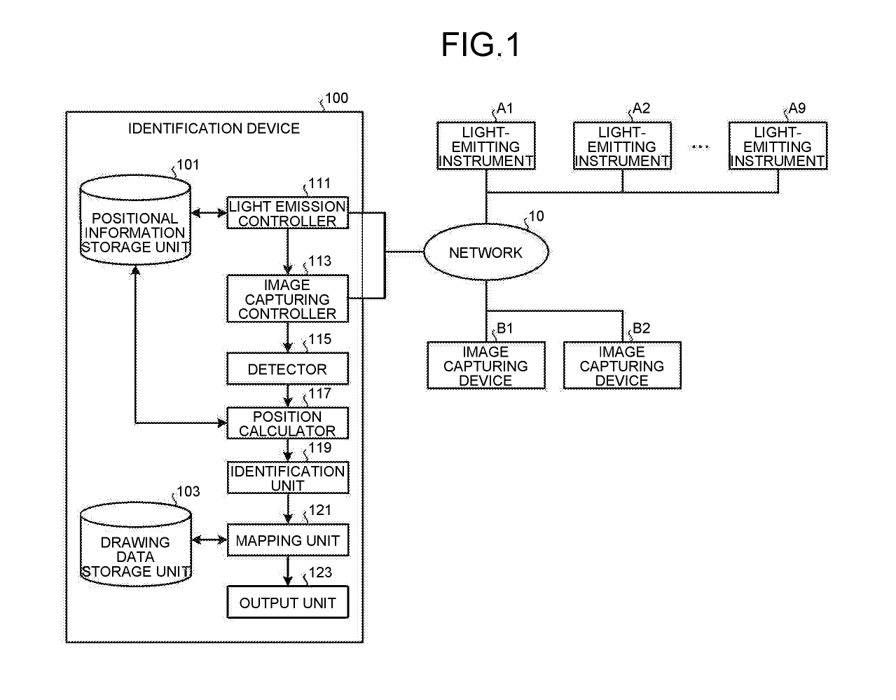

FIG. 1 is a diagram illustrating an example of a configuration of an identification device 100 according to a first embodiment. As illustrated in FIG. 1, the identification device 100 includes a positional information storage unit 101, a drawing data storage unit 103, a light emission control unit 111, an image capturing control unit 113, a detector 115, a position calculator 117, an identification unit 119, a mapping unit 121, and an output unit 123. The identification device 100 is connected to a plurality of light-emitting instruments A1 to A9 and a plurality of image capturing devices B1 and B2 via a network 10.

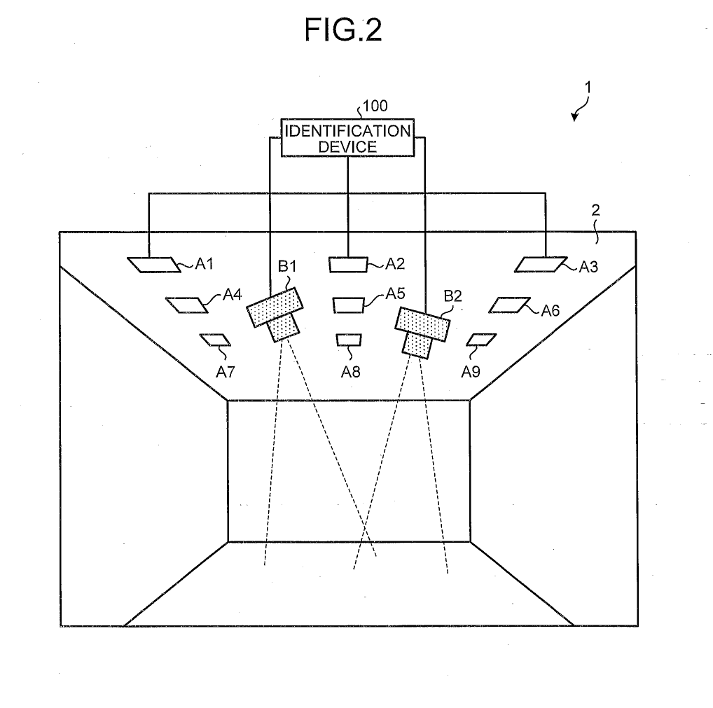

FIG. 2 is a perspective view illustrating an example of a place (hereinafter referred to as “space 1”) to which the identification device 100 according to the first embodiment is applied. As illustrated in FIG. 2, the light-emitting instruments A1 to A9 are installed in a grid and the image capturing devices B1 and B2 are installed on a ceiling 2 of the space 1. The image capturing devices B1 and B2 are installed on the ceiling 2 to capture an image in a direction of a floor of the space 1. In the first embodiment, it is assumed that the space 1 refers to space in an office, but is not limited to this case. The space 1 may be any space as long as light-emitting instruments and image capturing devices are placed therein. The numbers of light-emitting instruments and image capturing devices are not specifically limited as long as each of the numbers is two or more. In addition, in the first embodiment, it is assumed that image capturing devices are installed on the ceiling 2, but is not limited to this case. The image capturing devices may be installed in any place as long as positions where the image capturing devices are installed are known, such as an upper portion of a wall.

First, the light-emitting instruments A1 to A9 will be described. The following description may refer to the light-emitting instruments A1 to A9 as a light-emitting instrument A when it is not necessary to distinguish each of the light-emitting instruments A1 to A9.

In the first embodiment, it is assumed that the light-emitting instrument A is a lighting apparatus whose primary function is light emission, but is not limited to this case. The light-emitting instrument A may be any instrument as long as the instrument has the light-emitting function. The light-emitting function does not necessarily need to be a primary function of the light-emitting instrument A.

Alternatively, the light-emitting instrument A may be an instrument having an element such as a lamp and a light-emitting diode (LED) for visual check of an operating condition of the instrument, such as, for example, an air-conditioning apparatus, a human motion sensor, a temperature sensor, and a humidity sensor.

The light-emitting instruments A1 to A9 do not need to be a single-type light-emitting instrument. Multiple types of light-emitting instruments may be mixed. In other words, all of the light-emitting instruments A1 to A9 do not need to be lighting apparatuses, air-conditioning apparatuses, human motion sensors, temperature sensors, or humidity sensors. For example, a lighting apparatus, an air-conditioning apparatus, and a human motion sensor may be mixed. Alternatively, apparatuses may be mixed by another combination.

Each of the light-emitting instruments A1 to A9 has identification information, such as a MAC address and an IP address. The use of the identification information enables lighting on/off control via the network 10, that is, on/off control of the light-emitting function via the network 10.

Therefore, the use of the identification information of the light-emitting instruments A1 to A9 enables the identification device 100 to fully control lighting on/off of the light-emitting instruments A1 to A9, such as turning on a specific light-emitting instrument and turning off a remaining light-emitting instrument among the light-emitting instruments A1 to A9, and repeatedly turning on and off a specific light-emitting instrument.

The first embodiment assumes a case where the identification information of the light-emitting instrument A is a MAC address, but is not limited to this case. Any identification information may also be used as long as the identification information is used for network control, such as, for example, an IP address.

In addition, in the first embodiment, it is assumed that the positions of the light-emitting instruments A1 to A9 in the space 1 are known, and that the identification information and the positional information indicating the position of each of the light-emitting instruments A1 to A9 are associated with each other.

Next, the image capturing devices B1 and B2 will be described. The following description may refer to the image capturing devices B1 and B2 as an image capturing device B when it is not necessary to distinguish each of the image capturing devices B1 and B2.

In the first embodiment, it is assumed that the image capturing device B is a surveillance camera whose primary function is an image capturing, but is not limited to this case. Any instrument may be used as the image capturing device B as long as the instrument has an image capturing function. The instrument does not necessarily need to have an image capturing function as a primary function.

Each of the image capturing devices B1 and B2 has identification information, such as a MAC address and an IP address. The use of the identification information enables control of the image capturing device B via the network 10. In the first embodiment, it is assumed that the identification information of the image capturing device B is an IP address, but is not limited to this case. Any identification information may be used as long as the identification information is used for network control, such as, for example, a MAC address.

Furthermore, in the first embodiment, it is assumed that the image capturing device B captures light emitted from the light-emitting instrument A and reflected from an object such as a floor and a wall of the space 1. Accordingly, the image capturing device B shall include an image sensor capable of capturing (observing) the reflected light emitted from the light-emitting instrument A. The image to be captured by the image capturing device B may be a gray-scale image or a color image.

In the first embodiment, it is assumed that positions of the image capturing devices B1 and B2 in the space 1 are unknown.

Returning to FIG. 1, each unit of the identification device 100 will be described.

The positional information storage unit 101 and the drawing data storage unit 103 may be implemented by devices such as, for example, a hard disk drive (HDD) and a solid state drive (SSD).

The light emission control unit 111, the image capturing control unit 113, the detector 115, the position calculator 117, the identification unit 119, and the mapping unit 121 may be implemented by, for example, execution of a program by a processing device, such as a central processing unit (CPU), that is, by software. The light emission control unit 111, the image capturing control unit 113, the detector 115, the position calculator 117, the identification unit 119, and the mapping unit 121 may be implemented by hardware, such as an integrated circuit (IC), or by hardware and software together. The output unit 123 may be implemented by, for example, a display device, such as a liquid crystal display and a touch panel display, or a printing device, such as a printer.

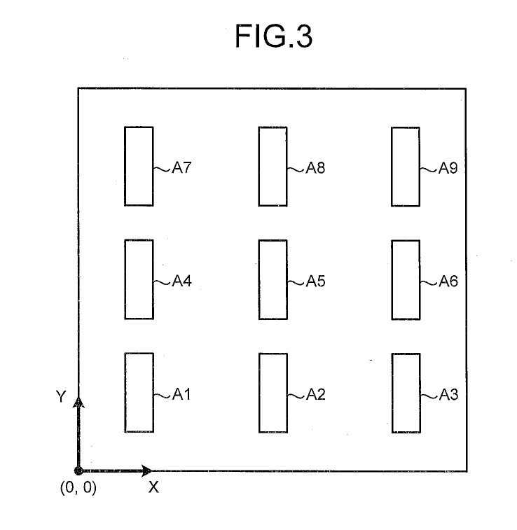

The positional information storage unit 101 stores therein the identification information of the light-emitting instrument A and the positional information indicating the position of the light-emitting instrument A in the space 1 so as to be associated with each other. In the first embodiment, the position of the light-emitting instrument A shall be expressed by an x-coordinate and a y-coordinate in a three-dimensional coordinate system of the space 1, that is, in a two-dimensional coordinate system that expresses the space 1 in a plan view, as illustrated in FIG. 3.

The drawing data storage unit 103 will be described later.

The light emission control unit 111 individually controls lighting on/off of the light-emitting instruments A1 to A9 via the network 10. Specifically, the light emission control unit 111 transmits a control signal including a lighting on/off command instructing lighting timing and lights-out timing, and the identification information of the light-emitting instrument A to be instructed by the lighting on/off command, to the light-emitting instrument A via the network 10. The light emission control unit 111 thereby controls lighting on/off of the light-emitting instrument A.

In the first embodiment, it is assumed that the light emission control unit 111 transmits a control signal to the light-emitting instruments A1 to A9 by broadcast. Accordingly, in the first embodiment, the control signal associates the identification information (MAC address) with the lighting on/off command of each of the light-emitting instruments A1 to A9. Thus, the control signal is transmitted to all the light-emitting instruments A1 to A9.

When the control signal is received, each of the light-emitting instruments A1 to A9 then checks whether the received control signal includes the light-emitting instrument's own identification information. When the light-emitting instrument's own identification information is included, the light-emitting instrument turns on and off according to the lighting on/off command associated with the identification information of the light-emitting instrument.

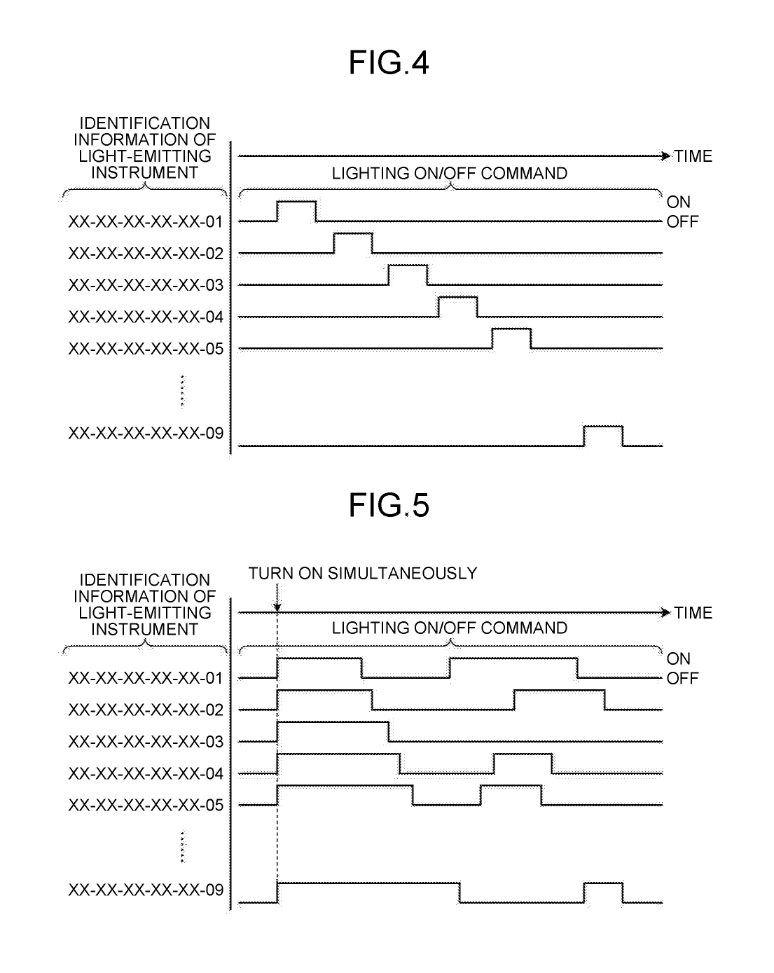

FIG. 4 is a diagram illustrating an example of the control signal according to the first embodiment. As described above, the control signal associates the identification information of each of the light-emitting instruments A1 to A9 with the lighting on/off command thereof. In the example illustrated in FIG. 4, an on period of the lighting on/off command denotes turning on the light-emitting instrument A, and an “off” period of the lighting on/off command denotes turning off the light-emitting instrument A.

As will be described in detail later, the detector 115 to be described later utilizes change timing when a lighting on/off condition of each of the light-emitting instruments A1 to A9 changes. Accordingly, in the control signal illustrated in FIG. 4, the lighting on/off command is configured to have different change timing of the lighting on/off condition among each of the light-emitting instruments A1 to A9. The change timing denotes at least one of timing when a change occurs from a lighting on condition to a lighting off condition, and timing when a change occurs from the lighting off condition to the lighting on condition.

However, it is not necessary to configure the lighting on/off command so that both of the timing from the lighting on condition to the lighting off condition and the timing from the lighting off condition to the lighting on condition differ among the light-emitting instruments A1 to A9. The lighting on/off command may be configured so that at least either one of the above-described two types of timing differ among the light-emitting instruments A1 to A9.

In other words, the lighting on/off command may be configured to enable the light emission control unit 111 to control lighting on/off of the light-emitting instruments A1 to A9 so that the change timing differs among the light-emitting instruments A1 to A9.

FIG. 5 is a diagram illustrating another example of the control signal according to the first embodiment. In the control signal illustrated in FIG. 5, the lighting on/off command is configured so that at least the change timing from the lighting on condition to the lighting off condition differs among the light-emitting instruments A1 to A9.

As is the case with the control signal illustrated in FIG. 4, the lighting on/off command may be configured to avoid a simultaneous lighting on condition of each of the light-emitting instruments A1 to A9. As is the case with the control signal illustrated in FIG. 5, in contrast, the lighting on/off command may be configured to cause at least some of the light-emitting instruments A1 to A9 to be in a simultaneous lighting on condition. Contrary to the control signal illustrated in FIG. 4, the lighting on/off command may be configured to avoid a simultaneous lighting off condition of each of the light-emitting instruments A1 to A9.

It should be noted that the control signal illustrated in FIG. 4 and FIG. 5 is an example. When the detector 115 to be described later may utilize change timing, the light emission control unit 111 may use various lighting on/off control methods.

In addition, the light emission control unit 111 may transmit a control signal to the light-emitting instruments A1 to A9 by unicast or multicast. For example, when a control signal is transmitted by unicast, the light emission control unit 111 may prepare a control signal that associates identification information of the light-emitting instrument A with a lighting on/off command for each of the light-emitting instruments A1 to A9, and then transmit the control signal to each of the light-emitting instruments A1 to A9. In this case, the IP address is preferably used, not the MAC address, as the identification information.

The image capturing control unit 113 controls image sequence capturing of the space 1 by the image capturing devices B1 and B2 by using the identification information of each of the image capturing devices B1 and B2, and obtains an image sequence captured by each of the image capturing devices B1 and B2. In the first embodiment, as described above, the image capturing devices B1 and B2 are installed on the ceiling 2 to capture an image in the direction of the floor of the space 1. Accordingly, in the first embodiment, the image capturing control unit 113 causes the image capturing devices B1 and B2 to capture image sequences of light reflected in the space 1 from the light-emitting instruments A1 to A9 that perform lighting on/off individually.

The detector 115 detects, for each of image sequences captured by the image capturing devices B, one or more regions that vary in conjunction with lighting on/off of the light-emitting instruments A1 to A9. As the region that varies in conjunction with lighting on/off of the light-emitting instruments A1 to A9, a region in the image in which a pixel value, such as brightness, varies by reflection of light emitted from the light-emitting instrument A may be considered, such as a floor and a wall of the space 1.

For example, the detector 115 acquires, from the light emission control unit 111, the identification information and the lighting on/off command of each of the light-emitting instrument A1 to A9 used for lighting on/off control of the light-emitting instruments A1 to A9 by the light emission control unit 111. The detector 115 then specifies time t0 of change timing when the lighting on/off condition of the light-emitting instrument A1 changes at timing different from that of other light-emitting instruments A2 to A9.

The detector 115 then acquires, for each of image sequences captured by the image capturing devices B, an image (t0−t1) at time t0−t1 and an image (t0+t2) at time t0+t2. The detector 115 calculates a difference of a pixel (for example, brightness) between the image (t0−t1) and the image (t0+t2). The detector 115 then detects a region in which the difference of the pixel exceeds a predetermined threshold value as a region that varies in conjunction with lighting on/off of the light-emitting instrument A1.

The reference numerals t1 and t2 denote predetermined positive numbers. Specifically, t1 and t2 are positive numbers determined so that the lighting on/off condition of the light-emitting instrument A1 at the time t0−t1 differs from that at the time t0+t2. Accordingly, it is preferable that t1<t2.

The number Mt0 of the detected variation region is expected to be 1 because the lighting on/off condition of only the light-emitting instrument A1 is supposed to change at the time t0.

Accordingly, if Mt0=1, the detector 115 determines that the detected region is a region in which light emitted from the light-emitting instrument A1 is reflected. The detector 115 then associates positional information of the light-emitting instrument A1 with an image sequence in which the region is detected. Specifically, the detector 115 acquires the positional information associated with the identification information of the light-emitting instrument A1 from the positional information storage unit 101, and then associates the positional information with the image sequence in which the region is detected.

When Mt0>1, however, the detector 115 determines that the detected region also includes a region other than the region in which the light emitted from the light-emitting instrument A1 is reflected. Thus, the detector 115 does not associate the positional information of the light-emitting instrument A1 with the image. For example, when light comes into the space 1 from outside, Mt0 is probably greater than 1.

In addition, when Mt0=0, the detector 115 determines that the detector 115 fails to detect a region in which light emitted from the light-emitting instrument A1 is reflected. Accordingly, the detector 115 does not associate the positional information of the light-emitting instrument A1 with the image.

With respect to the light-emitting instruments A2 to A9, the same process as that described above is repeated. As a result, the detector 115 detects, for each of image sequences captured by the image capturing devices B, one or more regions that vary in conjunction with each of the lighting on/off of the light-emitting instruments A1 to A9. The detector 115 then associates the image sequence with the positional information of the light-emitting instrument A that has performed lighting on/off causing each of the one or more regions.

The position calculator 117 calculates, for each image sequence, the position of the image capturing device that captures the image sequence by using the position of the light-emitting instrument that performs lighting on/off causing each of the one or more regions. Specifically, the position calculator 117 calculates, for each image sequence, one or more existence possibility areas in which the image capturing device B that captures the image sequence may exist, by using the position of the light-emitting instrument that performs lighting on/off causing each of the one or more regions. The position calculator 117 then calculates the position of the image capturing device B that captures the image sequence based on the one or more existence possibility areas. The position of the image capturing device B shall be expressed by an x-coordinate and a y-coordinate in a three-dimensional coordinate system of the space 1, that is, in a two-dimensional coordinate system that expresses the space 1 in a plan view, in a similar way to the position of the light-emitting instrument A.

The existence possibility area is expressed by a geometrical shape that depends on the light-emitting instrument A that performs lighting on/off causing the region detected by the detector 115, or a probability distribution indicating an existence probability. The geometrical shape depending on the light-emitting instrument A refers to a shape of the light-emitting instrument A or a shape depending on a direction of light emitted from the light-emitting instrument A. Examples of the geometrical shapes depending on the light-emitting instrument A include a circle, an ellipse, and a rectangle. The position calculator 117 determines a size of the existence possibility area based on at least one of a size of the region detected by the detector 115 and a pixel value of the detected region.

The calculation of the position of the image capturing device will be described in detail below.

First, the position calculator 117 calculates, for each image sequence, the existence possibility area from positional information of each of the one or more light-emitting instruments A associated with the image sequence by the detector 115.

For example, assume that the positional information of each of the light-emitting instruments A5, A1, and A2 is associated with the image sequence picked up by the image capturing device B1. In this case, the position calculator 117 calculates the existence possibility area from the positional information of each of the light-emitting instruments A5, A1, and A2.

Explanation is given below for a case in which the position calculator 117 calculates the existence possibility area from the positional information of the light-emitting instrument A5. In particular, the position calculator 117 calculates the existence possibility area of the image capturing device B1 based on the positional information of the light-emitting instrument A5 by using the region that varies in conjunction with lighting on/off of the light-emitting instrument A5 detected by the detector 115 and the positional information of the light-emitting instrument A5.

For example, when the existence possibility area is expressed as a circle, a position (xi, yi) of the image capturing device B1 may be calculated by the equations (1) and (2):

xi=xc+r cos θ (1)

yi=yc+r sin θ (2)

where xc and yc are positions (positional coordinates) indicated by the positional information of the light-emitting instrument A5, r is a radius of the existence possibility area (circle), and θ is an angle of the existence possibility area (circle). r has a value larger than 0 degrees and smaller than a threshold value th. Any angle in a range from 0 degree to 360 degrees inclusive corresponds to θ.

The position calculator 117 then determines the size (r) of the existence possibility area depending on the size of the region that varies in conjunction with lighting on/off of the light-emitting instrument A5 detected by the detector 115.

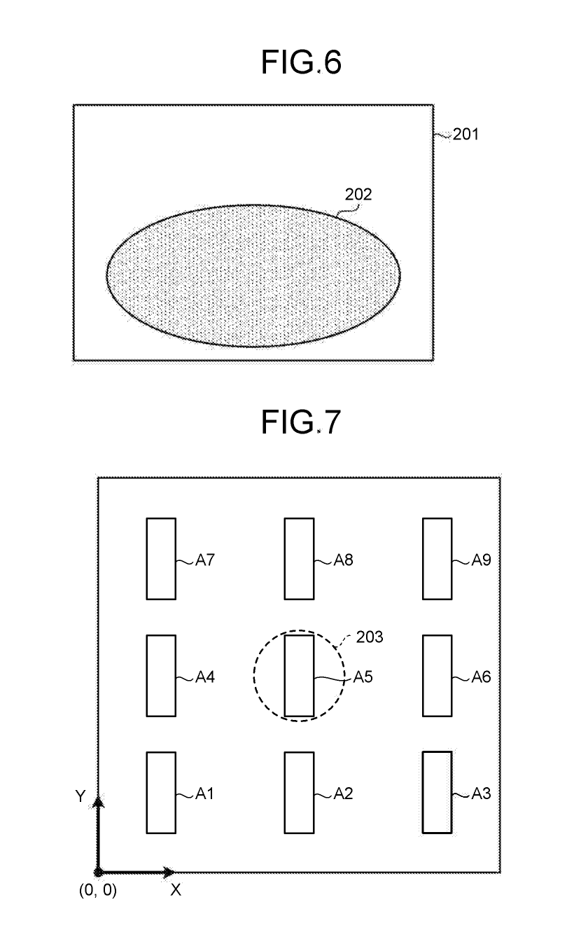

For example, as illustrated in FIG. 6, a large area of a region 202 that varies in conjunction with lighting on/off of the light-emitting instrument A5 on an image 201 captured by the image capturing device B1 denotes that the position of the image capturing device B1 is close to the position of the light-emitting instrument A5. Accordingly, the position calculator 117 reduces a size (size of r) of an existence possibility area 203 of the image capturing device B1 by reducing the threshold value th, as illustrated in FIG. 7.

Specifically, the relationship between the area of the region that varies in conjunction with lighting on/off of the light-emitting instrument A and the threshold value th is set in advance so that the threshold value th becomes smaller as the area of the region becomes larger. The position calculator 117 adopts the threshold value th depending on the area of the region.

An example in which the existence possibility area is expressed by a circle, which is a geometrical shape, has been described. Alternatively, the existence possibility area may be expressed by a probability distribution (continuous value) that indicates an existence probability of the image capturing device B1, such as likelihood. A normal distribution or the like may be used as the probability distribution.

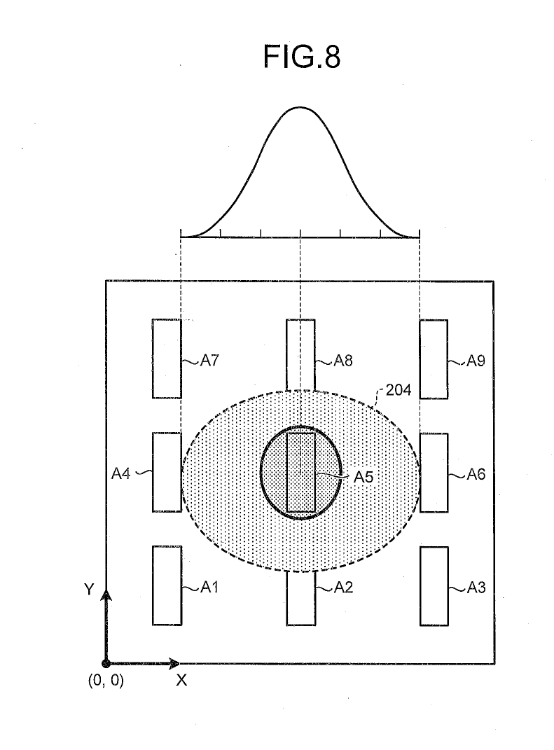

For example, as illustrated in FIG. 6, if the area of the region 202 that varies in conjunction with lighting on/off of the light-emitting instrument A5 on the image 201 captured by the image capturing device B1 is large, the position calculator 117 may set a normal distribution 204 in which the likelihood becomes smaller as moving away from a position (xc, yc) of the light-emitting instrument A5, as illustrated in FIG. 8.

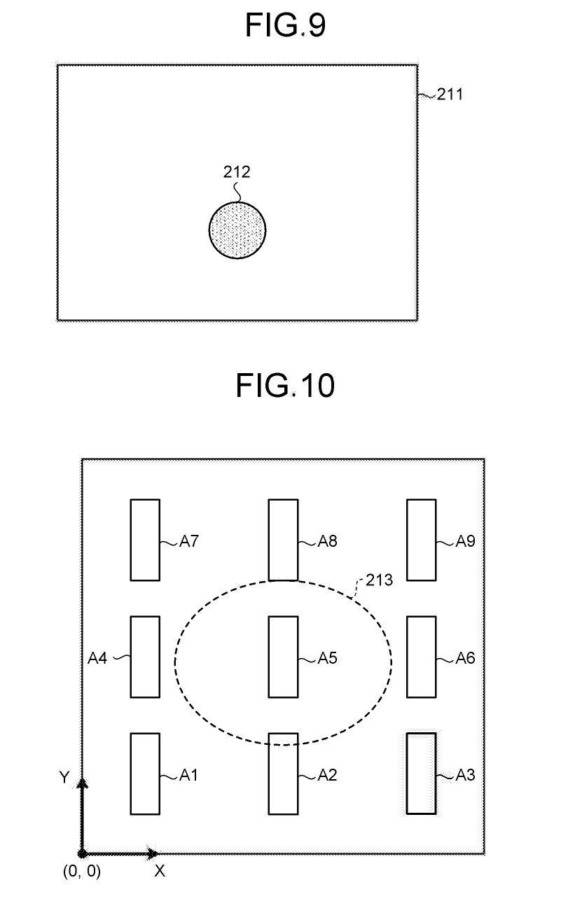

For example, as illustrated in FIG. 9, a small area of a region 212 that varies in conjunction with lighting on/off of the light-emitting instrument A5 on an image 211 captured by the image capturing device B1 denotes that the position of the image capturing device B1 is far from the position of the light-emitting instrument A5. Accordingly, the position calculator 117 increases a size (size of r) of an existence possibility area 213 of the image capturing device B1 by increasing the threshold th, as illustrated in FIG. 10.

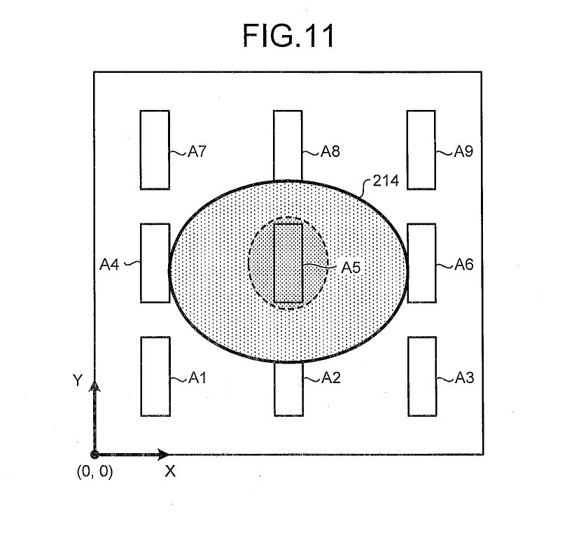

For example, as illustrated in FIG. 9, if the area of the region 212 that varies in conjunction with lighting on/off of the light-emitting instrument A5 on the image 211 picked up by the image capturing device B1 is small, the position calculator 117 may set a normal distribution 214 in which the likelihood becomes larger as the position calculator 117 moves farther away from the position (xc, yc) of the light-emitting instrument A5, as illustrated in FIG. 11.

The examples have been described in which the size of the region that varies in conjunction with lighting on/off of the light-emitting instrument A5 detected by the detector 115 is used to determine the size of the existence possibility area. Alternatively, a pixel value, such as a brightness value of the region, may be used, and both may be used together. When the brightness value of the region is used, a higher brightness value denotes that the position of the image capturing device B1 is closer to the position of the light-emitting instrument A5. A lower brightness value denotes that the position of the image capturing device B1 is farther from the position of the light-emitting instrument A5.

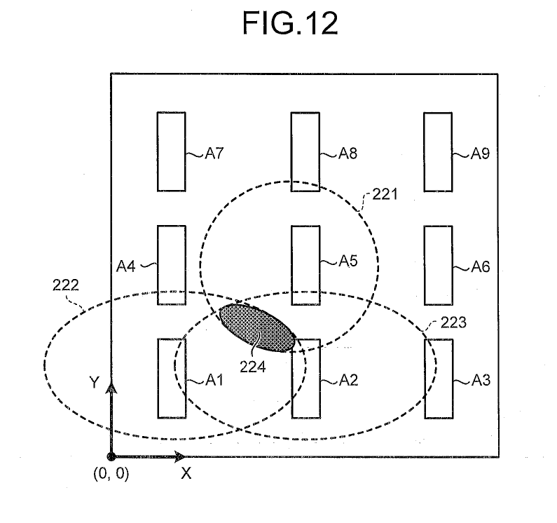

With respect to the light-emitting instruments A1 and A2, the same process as that described above is also repeated. As a result, as illustrated in FIG. 12, the position calculator 117 acquires an existence possibility area 221 of the image capturing device B1 based on the positional information of the light-emitting instrument A5, an existence possibility area 222 of the image capturing device B1 based on the positional information of the light-emitting instrument A1, and an existence possibility area 223 of the image capturing device B1 based on the positional information of the light-emitting instrument A2.

The position calculator 117 then defines a position specified by a logical product of one or more existence possibility areas or a position where likelihood of one or more existence possibility areas becomes maximum, as the position of the image capturing device that captures the image sequence. For example, when a position specified by a logical product of the existence possibility areas 221 to 223 is defined as the position of the image capturing device B1, the position calculator 117 defines a position 224 as the position of the image capturing device B1.

When there exist a plurality of positions (positions where most numerous existence possibility areas overlap) specified by logical products of one or more existence possibility areas, the position calculator 117 may define all of the plurality of positions as the positions of the image capturing device B1. When the position of the image capturing device B1 is predefined, a position closest to the predefined position among the plurality of positions may be defined as the position of the image capturing device B1.

When the existence possibility area is expressed by the probability distribution, the position calculator 117 may define a position where a value obtained by adding likelihood of probability distributions at each position becomes maximum as the position of the image capturing device B1. The value obtained by adding likelihood may be normalized.

The identification unit 119 identifies each of the plurality of image capturing devices B specified by the position calculated by the position calculator 117 and each of the plurality of image capturing devices B specified by the identification information. Specifically, the identification unit 119 associates the identification information of each of the image capturing devices B1 and B2 with the position of each of the image capturing devices B1 and B2 to thereby identify each of the image capturing devices B1 and B2 specified by the identification information and each of the image capturing devices B1 and B2 specified by the position.

The drawing data storage unit 103 will be described below. The drawing data storage unit 103 stores therein drawing data. The drawing data may be any types of data representing a layout of the space 1. For example, drawing data of a plan view or drawing data of a layout diagram of the space 1 may be used.

The mapping unit 121 acquires the drawing data of the space 1 from the drawing data storage unit 103, and performs mapping on the acquired drawing data while associating the position of each of the identified image capturing devices with the identification information thereof.

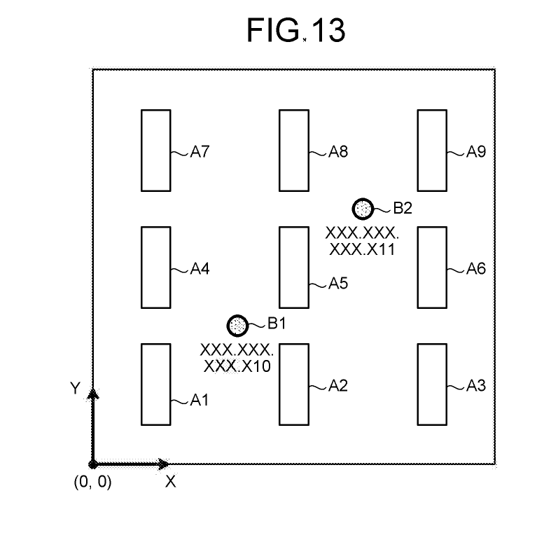

FIG. 13 is a diagram illustrating an example of a mapping result according to the first embodiment. In the example illustrated in FIG. 13, an element (for example, an icon) representing each of the image capturing devices B1 and B2 is mapped on a position of the image capturing devices B1 and B2 on drawing data of a plan view. Identification information of the image capturing device B1 (XXX.XXX.XXX.X10) is mapped in the vicinity of the element representing the image capturing device B1. Identification information of the image capturing device B2 (XXX.XXX.XXX.X11) is mapped in the vicinity of the element representing the image capturing device B2.

The output unit 123 outputs the drawing data in which the position and the identification information of each of the identified image capturing devices B1 and B2 are mapped by the mapping unit 121.

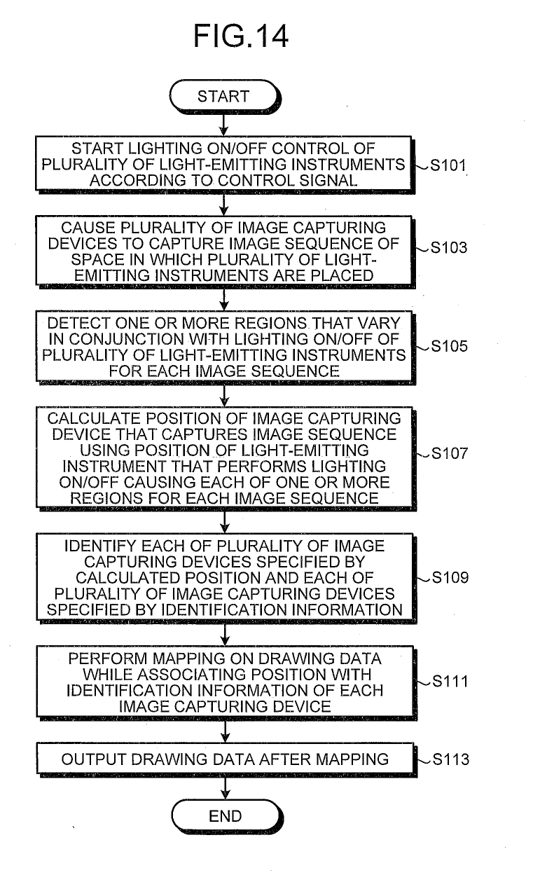

FIG. 14 is a flow chart illustrating an example of a procedure flow of an identification process performed by the identification device 100 according to the first embodiment.

First, the light emission control unit 111 starts lighting on/off control of the plurality of light-emitting instruments A1 to A9 via the network 10 according to the control signal (step S101).

Subsequently, the image capturing control unit 113 causes each of the image capturing devices B1 and B2 to capture an image sequence of the space 1 by using the identification information of each of the image capturing devices B1 and B2 (step S103).

Subsequently, the detector 115 detects, for each of the image sequences captured by the image capturing devices B, one or more regions that vary in conjunction with lighting on/off of the light-emitting instruments A1 to A9 (step S105).

Subsequently, the position calculator 117 calculates the position of the image capturing device that captures, for each image sequence, the image sequence by using the position of the light-emitting instrument that performs lighting on/off causing each of the one or more regions (step S107).

Subsequently, the identification unit 119 identifies each of the plurality of image capturing devices B specified by the position calculated by the position calculator 117, and each of the plurality of image capturing devices B specified by the identification information (step S109).

Subsequently, the mapping unit 121 acquires the drawing data of the space 1 from the drawing data storage unit 103, and performs mapping on the acquired drawing data by associating the position of each of the identified image capturing devices B with the identification information thereof (step S111).

Subsequently, the output unit 123 outputs the drawing data in which the position and the identification information of each of the identified image capturing devices B1 and B2 are mapped by the mapping unit 121 (step S113).

As described above, the identification device according to the first embodiment performs lighting on/off of the plurality of light-emitting instruments individually. The identification device then causes the plurality of image capturing devices to capture an image sequence of the plurality of light-emitting instruments that perform lighting on/off individually. The identification device then detects, for each image sequence, one or more regions that vary in conjunction with lighting on/off of the plurality of light-emitting instruments. The identification device then calculates, for each image sequence, the position of the image capturing device that captures the image sequence by using the position of the light-emitting instrument that performs lighting on/off causing each of the one or more regions. The identification device then identifies each of the plurality of image capturing devices specified by the position, and each of the plurality of image capturing devices specified by the identification information. Therefore, according to the first embodiment, the image capturing device specified by the position and the image capturing device specified by the identification information may be identified by simple work, leading to shorter identification manual work.

In addition, according to the first embodiment, because the position and the identification information of each of the identified image capturing devices are mapped on the drawing data representing the layout of the space and outputted, a user may easily understand a relative relationship between the position and the identification information of each of the image capturing devices.

### Second Embodiment

A second embodiment will describe an example of further calculating a direction of an image capturing device. The following description will focus on a difference from the first embodiment. Similar names and reference numerals to those in the first embodiment are used to denote components having similar functions to those in the first embodiment, and further description thereof will be omitted.

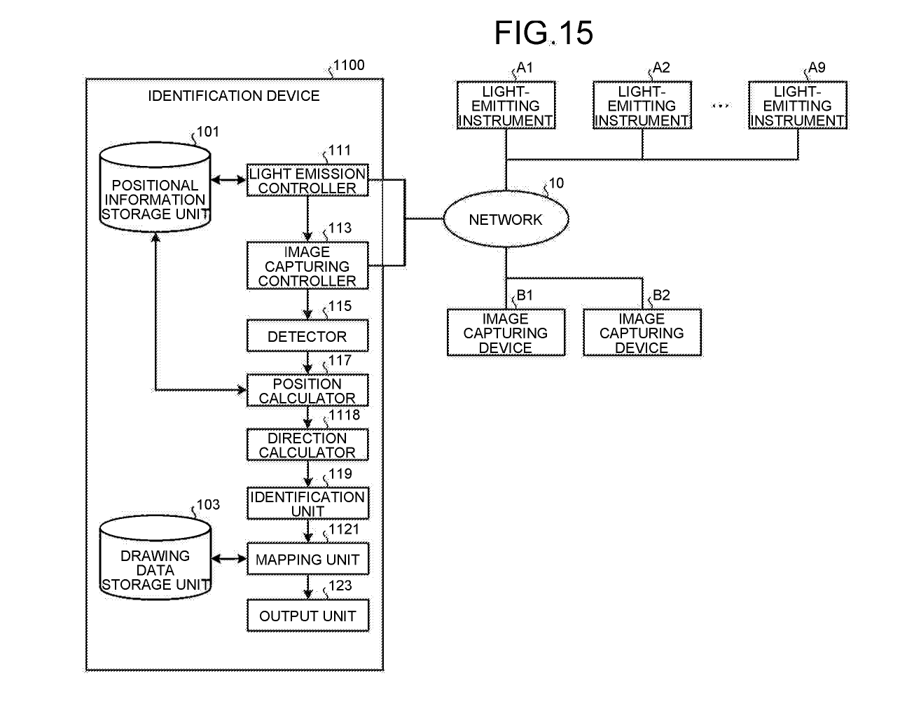

FIG. 15 is a diagram illustrating an example of a configuration of an identification device 1100 according to the second embodiment. As illustrated in FIG. 15, a direction calculator 1118 and a mapping unit 1121 of the identification device 1100 of the second embodiment are different from those of the first embodiment.

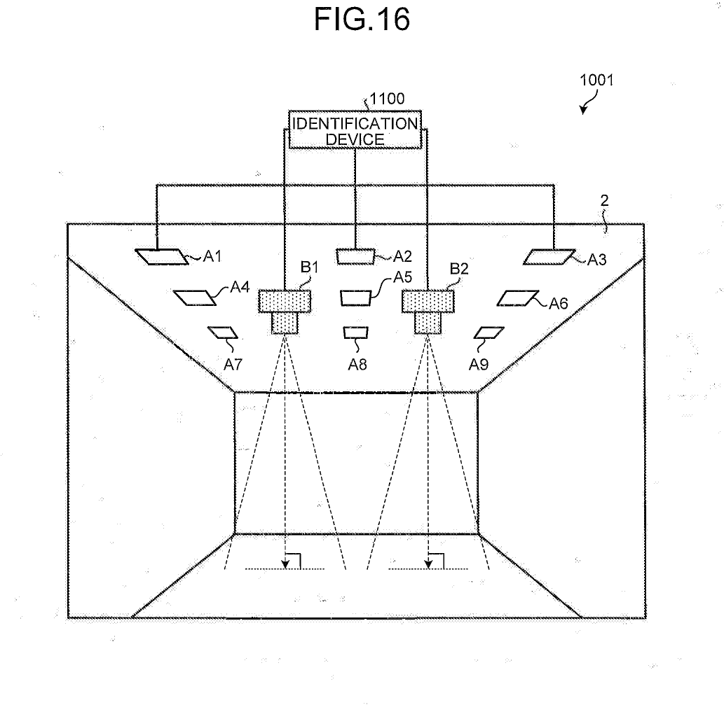

FIG. 16 is a perspective view illustrating an example of space 1001 to which the identification device 1100 according to the second embodiment is applied. In the second embodiment, as illustrated in FIG. 16, an image capturing device B is installed on a ceiling 2 so that an optical axis of the image capturing device B is perpendicular to a floor, that is, so that an angle between the optical axis of the image capturing device B and the floor is 90 degrees.

Returning to FIG. 15, the direction calculator 1118 calculates, for each image sequence, a direction of an image capturing device that captures the image sequence by using positions of one or more regions in the image in which each of the regions are detected. Specifically, the direction calculator 1118 classifies the position of the region in the image, and calculates the direction of the image capturing device B based on the classified position.

In the second embodiment, the image capturing device B is installed on the ceiling 2 to capture an image directly below (perpendicular direction). Therefore, the direction of the image capturing device B can be calculated from the position, in the image, of the region that varies in conjunction with lighting on/off of a light-emitting instrument A detected by the detector 115.

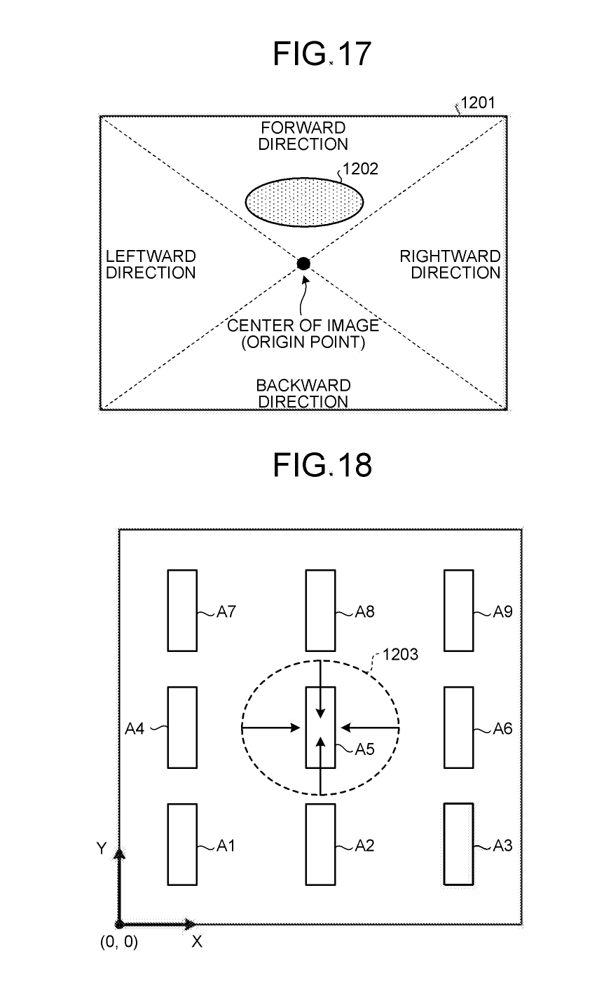

For example, as illustrated in FIG. 17, the direction calculator 1118 divides, by diagonal lines, an image 1201 in which a region 1202 that varies in conjunction with lighting on/off of the light-emitting instrument A is detected. The direction calculator 1118 then classifies the region 1202 into four directions of forward, backward, rightward and leftward.

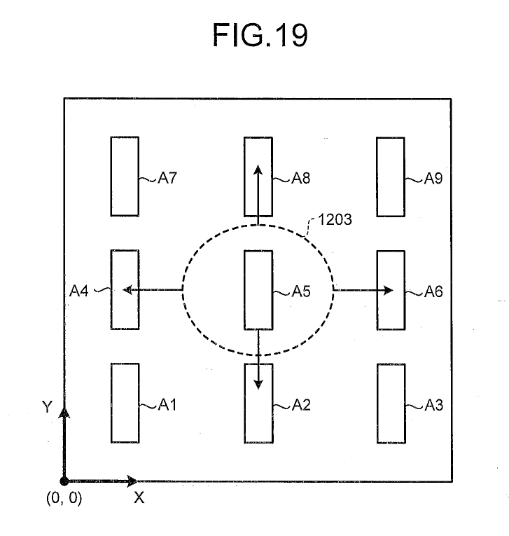

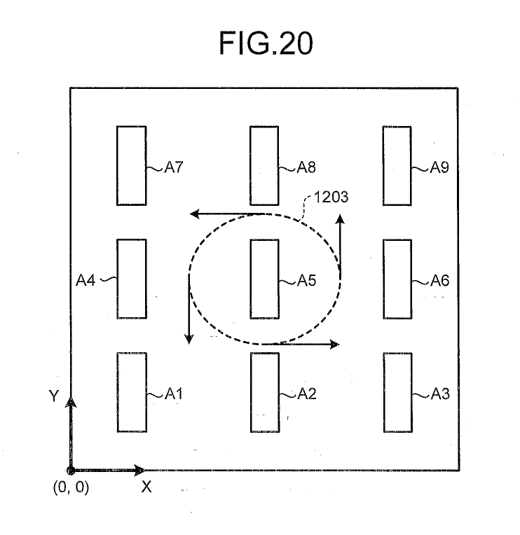

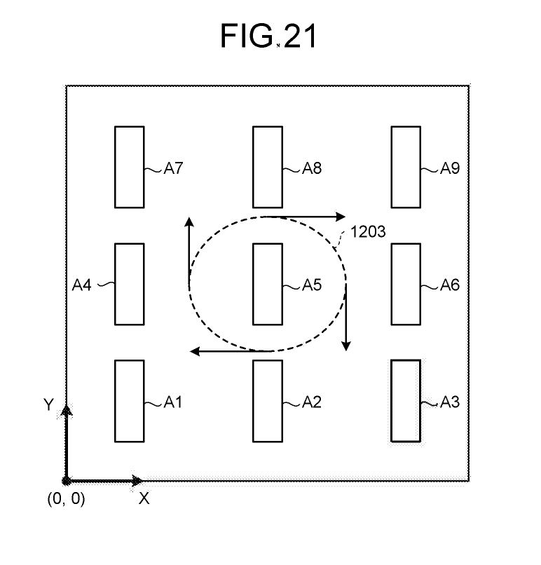

As illustrated in FIG. 17, when the region 1202 is classified into the forward direction, the direction calculator 1118 calculates that the image capturing device B points in a direction of a center of an existence possibility area 1203, as illustrated in FIG. 18. In the example illustrated in FIG. 17, when the region 1202 is classified into the backward direction, the direction calculator 1118 calculates that the image capturing device B points in an outward direction from the center of the existence possibility area 1203, as illustrated in FIG. 19. In the example illustrated in FIG. 17, when the region 1202 is classified into the leftward direction, the direction calculator 1118 calculates that the image capturing device B points in a counterclockwise direction tangent to the existence possibility area 1203, as illustrated in FIG. 20. In the example illustrated in FIG. 17, when the region 1202 is classified into the rightward direction, the direction calculator 1118 calculates that the image capturing device B points in a clockwise direction tangent to the existence possibility area 1203, as illustrated in FIG. 21.

In this way, in the second embodiment, the direction of the image capturing device B may be calculated from the position (direction), in the image, of the region that varies in conjunction with lighting on/off of the light-emitting instrument A. The second embodiment has described a case where the position (direction) of the region in the image is classified into four directions, but is not limited to this case. The position of the region in the image may be classified in more detail, for example, into eight directions.

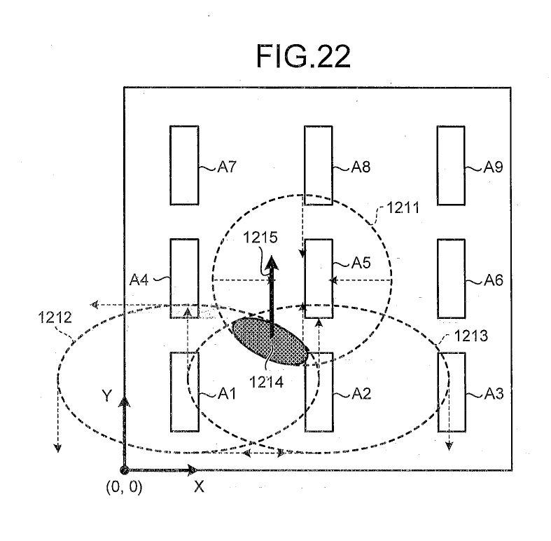

The direction calculator 1118 then defines the direction calculated in each of the one or more existence possibility areas as the direction of the image capturing device B1. For example, in an example illustrated in FIG. 22, in a position 1214 of the image capturing device B specified by a logical product of existence possibility areas 1211 to 1213, all of the existence possibility areas 1211 to 1213 indicate that the image capturing device B points in a forward direction. The direction calculator 1118 therefore defines a direction of an arrow 1215 as the direction of the image capturing device B. In the position of the image capturing device B, when the existence possibility areas indicate that the image capturing device B points in two or more directions, the direction calculator 1118 may define all of the two or more directions as the directions of the image capturing device B.

The mapping unit 1121 acquires drawing data of the space 1001 from the drawing data storage unit 103. The mapping unit 1121 then performs mapping on the acquired drawing data while associating the position and the direction of each of the plurality of identified image capturing devices with the identification information thereof.

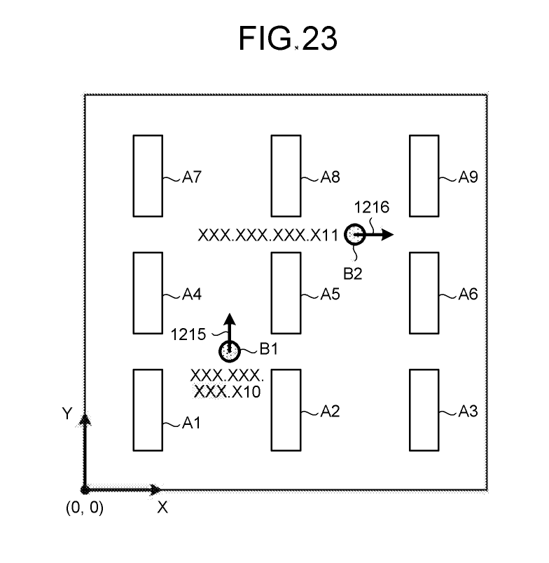

FIG. 23 is a diagram illustrating an example of a mapping result according to the second embodiment. In the example illustrated in FIG. 23, an element (for example, an icon) representing each of the image capturing devices B1 and B2 is mapped on the positions of the image capturing devices B1 and B2 on the drawing data of a plan view. An element (for example, arrows 1215 and 1216) representing the direction of each of the image capturing devices B1 and B2 is also mapped. Identification information of the image capturing device B1 (XXX.XXX.XXX.X10) is mapped in the vicinity of the element representing the image capturing device B1. Identification information of the image capturing device B2 (XXX.XXX.XXX.X11) is mapped in the vicinity of the element representing the image capturing device B2.

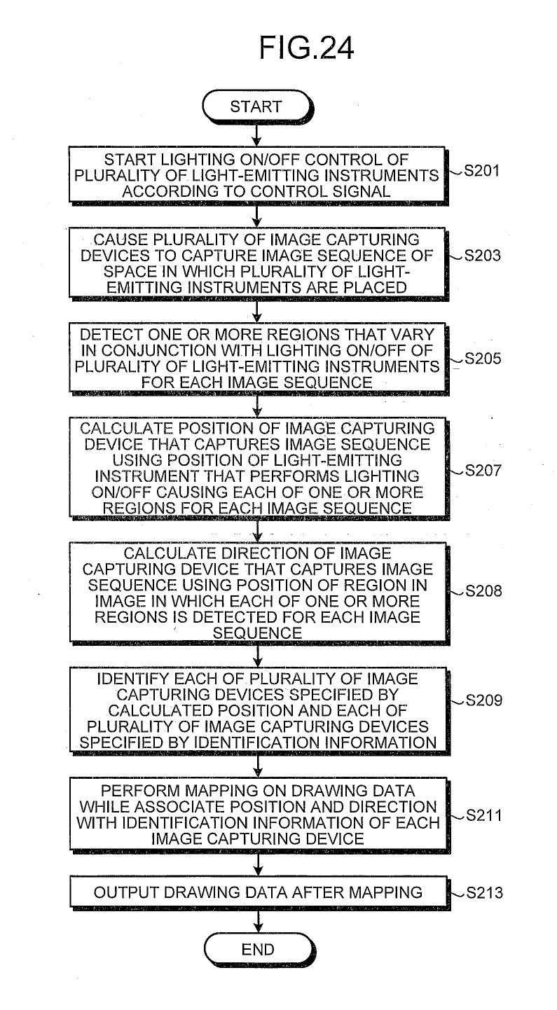

FIG. 24 is a flow chart illustrating an example of a procedure flow of an identification process performed by the identification device 1100 according to the second embodiment.

First, the process in steps from S201 to S207 is similar to that in steps from S101 to S107 of the flow chart illustrated in FIG. 14.

In step S208, the direction calculator 1118 calculates the direction of the image capturing device that picks up the image sequence by using the position of the one or more regions in the image in which each of the regions is detected for each image sequence.

Subsequently, the process in step S209 is similar to that in step S109 of the flow chart illustrated in FIG. 14.

In step S211, the mapping unit 1121 acquires the drawing data of the space 1001 from the drawing data storage unit 103, and performs mapping on the acquired drawing data while associating the position and the direction of each of the plurality of identified image capturing devices with the identification information thereof.

Subsequently, the process in step S213 is similar to that in step S113 of the flow chart illustrated in FIG. 14.

As described above, according to the second embodiment, in addition to the position of each of the plurality of image capturing devices, the direction thereof can be specified. A user may easily keep track of whether each of the image capturing devices points in a correct direction.

### First Modification

In each of the above-described embodiments, an image capturing device B may adjust settings such as exposure and white balance in advance so that a variation in a region that varies in conjunction with lighting on/off of a light-emitting instrument A may become conspicuous.

### Second Modification

In each of the above-described embodiments, a detector 115 may limit a region for detection to a portion in an image in a detection process of a region that varies in conjunction with lighting on/off of a light-emitting instrument A. For example, when light from the light-emitting instrument A is reflected by a floor of space 1, limiting the region for detection to the floor eliminates the need for detection outside the region for detection. False detection may also be reduced, and the detection process of the region is expected to be faster and more precise.

### Third Modification

Each of the above-described embodiments has described an example of using a size of a region that varies in conjunction with lighting on/off of a light-emitting instrument A detected by a detector 115 to determine a size of an existence possibility area. A distance between the region and an image capturing device B may also be used. In this case, the distance may be calculated from an object with a known size installed in space 1, or calculated using a sensor, such as a laser. In this case, a shorter distance denotes a position of the image capturing device B being closer to a position of the light-emitting instrument A. A longer distance denotes the position of the image capturing device B being farther from the position of the light-emitting instrument A.

Hardware Configuration

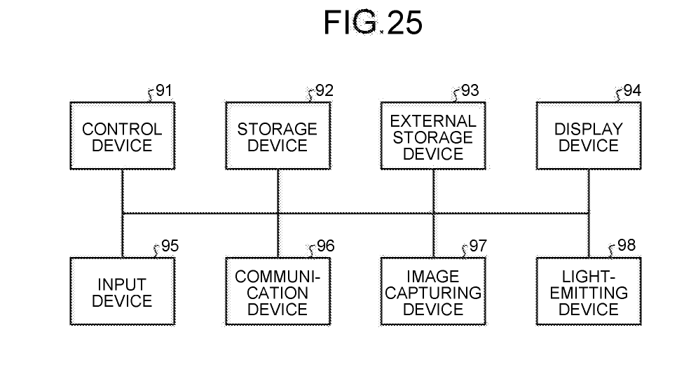

FIG. 25 is a block diagram illustrating an example of a hardware configuration of an identification device according to the above-described each embodiment and each variation. The identification device according to the above-described each embodiment and each variation includes a control device 91, such as a CPU, a storage device 92, such as a read only memory (ROM) and a random access memory (RAM), an external storage device 93, such as a HDD, a display device 94, such as a display, an input device 95, such as a keyboard and a mouse, a communication device 96, such as a communication interface, an image capturing device 97, such as a surveillance camera, and a light-emitting device 98, such as a lighting apparatus. The identification device has a hardware configuration using a standard computer.

A program to be executed by the identification device of the above-described each embodiment and each variation may be configured to be an installable file or an executable file. The program may be configured to be recorded in a computer-readable recording medium, such as a compact disk read only memory (CD-ROM), a compact disk recordable (CD-R), a memory card, a digital versatile disk (DVD), and a flexible disk (FD), and to be provided.

The program to be executed by the identification device of the above-described each embodiment and each variation may also be configured to be stored in a computer connected to a network, such as the Internet, and to be provided by allowing download via the network. The program to be executed by the identification device of the above-described each embodiment and each variation may also be configured to be provided or distributed via the network, such as the Internet. The program to be executed by the identification device of the above-described each embodiment and each variation may also be configured to be incorporated in a device such as a ROM in advance and then provided.

The program to be executed by the identification device of the above-described each embodiment and each variation has a module configuration for realizing the above-described each unit in a computer. An actual hardware is configured to realize the above-described each unit in a computer by the CPU reading the program from the HDD into the RAM for execution.

For example, each step in the flow chart of each of the above embodiments may be performed by changing execution sequence, performing a plurality of steps concurrently, or performing the steps in a different sequence each time the steps are performed, as long as such an action does not contradict the step's property.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An identification device comprising:
a light emission controller configured to individually control lighting on/off of a plurality of light-emitting instruments via a network;
an image capturing controller configured to control a plurality of image capturing devices by using identification information of each of the plurality of image capturing devices, and obtain an image sequence captured by each of the plurality of image capturing devices;
a detector configured to detect, for each image sequence, one or more regions that vary in conjunction with lighting on/off of the plurality of light-emitting instruments;
a position calculator configured to calculate, for each image sequence, a position of the image capturing device that captures the image sequence by using a position of the light-emitting instrument that performs lighting on/off causing each of the one or more regions; and
an identification unit configured to identify each of the plurality of image capturing devices specified by the calculated position and each of the plurality of image capturing devices specified by the identification information.

2. The device according to claim 1, further comprising a direction calculator configured to calculate, for each of the image sequences, a direction of the image capturing device that captures the image sequence by using a position of the one or more regions in the image in which each of the regions is detected.

3. The device according to claim 1, wherein the position calculator calculates, for each of the image sequences, one or more existence possibility areas in which the image capturing device that captures the image sequence exists by using the position of the light-emitting instrument that performs lighting on/off resulting in each of the one or more regions, and calculates the position of the image capturing device that captures the image sequence based on the one or more existence possibility areas.

4. The device according to claim 3, wherein the position calculator determines a size of the existence possibility area based on at least one of a size of the detected region and a pixel value of the detected region.

5. The device according to claim 3, wherein the existence possibility area is expressed by a geometrical shape that depends on the light-emitting instrument that performs lighting on/off causing the region, or a probability distribution indicating an existence probability.

6. The device according to claim 3, wherein the position calculator defines a position specified by a logical product of the one or more existence possibility areas or a position where likelihood of the one or more existence possibility areas is maximum, as a position of the image capturing device that captures the image sequence.

7. The device according to claim 2, wherein the direction calculator classifies the position of the region in the image, and calculates a direction of the image capturing device based on the classified position.

8. The device according to claim 1, further comprising a mapping unit configured to acquire drawing data of a place where the light-emitting instrument is installed, and performs mapping on the acquired drawing data while associating the position of each of the plurality of identified image capturing devices with the identification information thereof.

9. The device according to claim 1, wherein the region that varies in conjunction with lighting on/off of the plurality of light-emitting instruments is a region in which the pixel value varies by reflection of light emitted from the plurality of light-emitting instruments.

10. The device according to claim 1, wherein the plurality of light-emitting instruments are lighting apparatuses.

11. An identification method comprising:
individually controlling lighting on/off of a plurality of light-emitting instruments via a network;
controlling a plurality of image capturing devices by using identification information of each of the plurality of image capturing devices, and obtaining an image sequence captured by each of the plurality of image capturing devices;
detecting, for each of the image sequences, one or more regions that vary in conjunction with lighting on/off of the plurality of light-emitting instruments;
calculating, for each of the image sequences, a position of the image capturing device that captures the image sequence by using a position of the light-emitting instrument that performs lighting on/off causing each of the one or more regions; and
identifying each of the plurality of image capturing devices specified by the calculated position and each of the plurality of image capturing devices specified by the identification information.

12. A computer program product comprising a computer-readable medium containing a computer program, wherein the computer program, when executed by a computer, causes the computer to perform:
individually controlling lighting on/off of a plurality of light-emitting instruments via a network;
controlling a plurality of image capturing devices by using identification information of each of the plurality of image capturing devices, and obtaining an image sequence captured by each of the plurality of image capturing devices;
detecting, for each of the image sequences, one or more regions that vary in conjunction with lighting on/off of the plurality of light-emitting instruments;
calculating, for each of the image sequences, a position of the image capturing device that captures the image sequence by using a position of the light-emitting instrument that performs lighting on/off causing each of the one or more regions; and
identifying each of the plurality of image capturing devices specified by the calculated position and each of the plurality of image capturing devices specified by the identification information.
